(19) United States
(12) Patent Application Publication
(10) Pub. No.: US 2014/0029025 A1
(43) Pub. Date: Jan. 30, 2014

(54) PRINT JOB PREVIEW

(71) Applicants: Selma Casanovas Suriol, (US); Miriam LLorens Carrobe, Sabadell Barcelona (ES); Javier S. Lagares Garcia, Castellvi De la Marca (La Munia) (ES)

(72) Inventors: Selma Casanovas Suriol, (US); Miriam LLorens Carrobe, Sabadell Barcelona (ES); Javier S. Lagares Garcia, Castellvi De la Marca (La Munia) (ES)

(21) Appl. No.: 13/557,535

(22) Filed: Jul. 25, 2012

(51) Int. Cl. H04N 1/60; G06K 15/02

(52) U.S. Cl. 358/1.9; 358/1.15

(57) ABSTRACT

A method for providing a print job preview is disclosed. A print job is received and a raster image of the print job and a preview image representing the print job are generated. An output to a remote printer is generated, the output including the raster image of the print job and the preview image representing the print job.

### BACKGROUND

Print job preview systems are used to monitor printer activity and also to ensure that a print job matches a user's expectations.

### BRIEF DESCRIPTION OF THE DRAWINGS

The accompanying drawings illustrate various examples and are a part of the specification. The illustrated examples are examples and do not limit the scope of the claims. Throughout the drawings, identical reference numbers designate similar, but not necessarily identical elements.

FIG. 1 is a block diagram of a print job preview system according to various examples;

FIG. 2 is a schematic diagram illustrating elements of an output data stream, according to various examples;

FIGS. 3, 4a and 4b are block diagrams illustrating elements of printers, according to various examples.

FIG. 5 and 6 are flow diagrams depicting steps taken to implement various examples.

The same part numbers designate the same or similar parts throughout the figures.

### DETAILED DESCRIPTION

In certain printing systems, a print job preview may be offered on-screen at a client terminal prior to sending the print job to the printer. One difficulty with print job preview at the client terminal is that there is no indication at the printer as to what is being printed. Typical printing errors include sending the wrong print job to the printer, sending a print job to the wrong printer, having the wrong media (type or size) loaded to print that job, etc. Errors can lead to ink, media and power consumption wastage. One additional difficulty in the case of networked printers is that the printer may be physically situated some distance from the client and may service more than one client. In such networked arrangements, a user may not be able to see both the preview at the client and activity at the printer.

In certain printers, a print job preview may be offered via a display at or in the printer. The printer receives the print job in a high level format such as in a print description language like PDF and processes it, for example, using an embedded raster image processor (RIP) during which a preview image is generated. One difficulty with printers having an embedded RIP systems is that raster image processing (known as ripping) a print job can be a computationally intensive activity which results in delays between the print job being received by the printer and the printing commencing. Another difficulty is that a user must wait for ripping process in order for the preview image to be generated for viewing. As ripping of print jobs does not need to be completed before the printing starts, the user may decide not to wait for a preview image to be generated before instructing the printer to start printing.

Accordingly, various examples described herein were developed to provide a print job preview method that enables a print preview image of the print job to be generated and communicated to a printer with a raster image of the print job. In an example of the disclosure, a method for providing a print job preview comprises receiving a print job, generating a raster image of the print job, generating a preview image representing the print job and generating an output to a remote printer, the output including the raster image of the print job and the preview image representing the print job.

Advantages of the examples described herein include that a preview image ready for display is provided to the printer as part of the print job. An advantage of including a preview image with a raster image of a print job is that the image can be directed to a display, web server or the like without any processing of the raster image of the print job. Another advantage is that the preview image can be positioned in the file or data stream that is used for communicating with the printer so that it arrives at the printer ahead of the raster image of the print job. An advantage of the preview image arriving ahead of the raster image of the print job is that it can be displayed before the printer has completed receiving the raster image of the print job. An advantage of early display of the preview image is that an incorrect print job can be cancelled at the printer or paused until media adjusted, saving wasted media, ink and time as the amount of wastage produced from an unintended print job or printing a print job to an incorrectly configured printer depends on how fast the operator can realize there is a problem and cancel the job. Moreover, a further advantage is that downtime due to in-progress prints or plots being cancelled is avoided.

Another advantage of various examples is that a preview image can be communicated to the printer for display with halftone or contone print data. Generating a preview of a halftone or contone print data can be a computationally intensive process, which can be avoided in various examples.

Another advantage of various examples is that the generation of the preview image can be done at the time of generating the raster image to be printed, minimizing the chances of having the preview and the rasterized data being inconsistent.

Another advantage of various examples is that the RIP can be given control over the resolution of the preview image generated. Resolution can be selected to reflect the print job instead of the display at the printer. An advantage of this example is that a resolution can be selected to reflect a detail level needed to evaluate the print job without rendering at too much or too little information.

Another advantage of various examples is that the preview image can be available for display at both the client terminal and the printer so that, for example, in networked scenarios both the user and a printer operator can visualize what is being printed from a common preview image.

As used herein, a “printer” or “printing device” refers to any electronic device that prints and includes multifunctional electronic devices that perform additional functions such as scanning and/or copying.

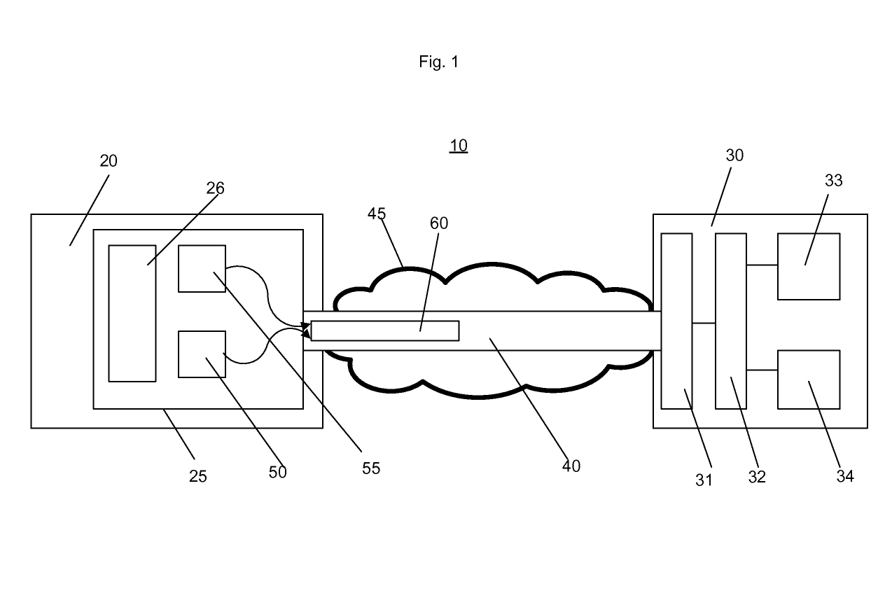

FIG. 1 is a block diagram illustrating a print job preview system, according to various examples. FIG. 1 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 1 shows a print job preview system 10. A client computer device, for example a PC, 20 is connected to a printer 30 by a communications link 40. In one example, the communications link 40 is over a data communications network 45 which may be wired, wireless or a combination of wired and wireless networks. In another example, the communications link is a direct connection between the client computer device and the printer which may be wired or wireless.

The client computer device 20 includes a printer driver module 25 that receives a print job. The printer driver module 25 processes the print job to generate a raster image 50. In one example, the printer driver module 25 includes a raster image processor (RIP) 26 which processes the print job to produce the raster image 50, also sometimes referred to as a bitmap. The printer driver module 25 also generates a preview image 55 corresponding to the print job. In one example, the RIP may generate halftone or contone data in producing the raster image.

In one example, the preview image is a JPEG format image. In one example the preview image is a JIFF type JPEG image. In other examples, the preview image may another image format such as png, GIF, etc. In one example, the preview image is compressed. In one example, the RIP 26 generates the preview image 55. In another example, another module (not shown) generates the preview image 55. In one example, the input to the RIP is a page description in a high-level page description language such as PostScript, Portable Document Format, XPS or another format. In one example, the RIP determines the resolution at which the preview image is generated. The image resolution and/or dimensions for the preview image may be determined from a number of factors including destination printer memory constraints, preview target screen resolution and dimensions, richness of expected user experience etc. In one example, the printer driver module 25 stores and uses preference for preview images for each target printer.

The printer driver module 25 assembles the preview image 55 and the raster image 50 into an output 60 to be communicated to the printer 30. In one example, the printer driver module 25 encapsulates the preview image 55 and the raster image 50 to form the output 60. In one example, the output 60 is a data stream. In another example, the output 60 is a data file.

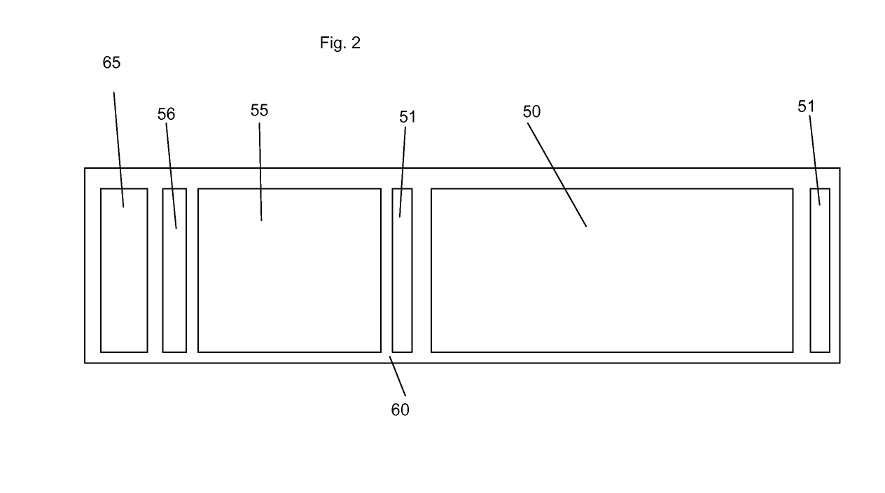

FIG. 2 is a schematic diagram illustrating elements of an output data stream, according to various examples. FIG. 2 includes particular components, modules, etc. according to various examples. However, in different examples, more, fewer, and/or other components, modules, arrangements of components/modules, etc. may be used according to the teachings described herein. In addition, various components, modules, etc. described herein may be implemented as software modules, data structures, encoded data, files, data streams or combinations of these.

In one example, schematically illustrated in FIG. 2, the printer driver module includes a raster image identifier 51 in the output 60 identifying a position of the raster image of the print job and a preview image identifier 56 identifying the position of the preview image in the output 60.

In one example, each identifier includes an escape sequence preceding and/or following the data encoding the respective image in the output 60. In one example, the escape sequence is a text string. In one example the identifier is a printer command language command. In one example, the identifier for the preview image is:

Esc*w#J

In one example, the output may include an identifier in a header or other position that references a position index of the preview image in the output 60.

In one example, the printer driver module orders the preview image in the output so the entire preview image is received at the printer before the complete raster image is received. In one example, the preview image is ordered ahead of the raster image in the output. In one example, the preview image is positioned in or following a header 65 of the output.

Referring again to FIG. 1, the output 60 is communicated to the printer over the communications link 40. The output 60 may be handled by a communications stack for the communications link for packetization and re-assembly and other communications functions, although it will be appreciated that these functions are dependent on the type of communications link and largely transparent to the client computer device 20 and the printer 30.

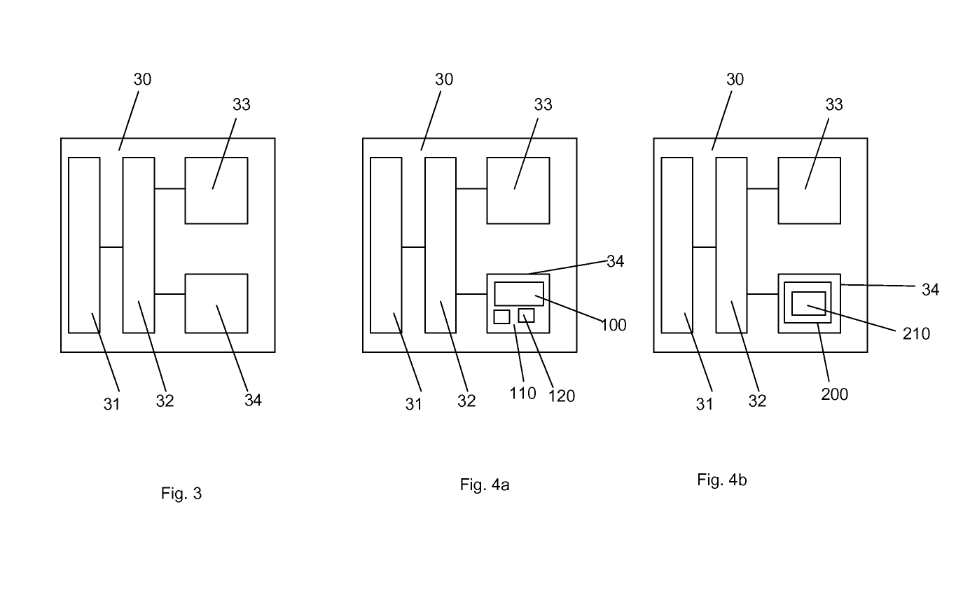

FIG. 3 is a block diagram illustrating a printer, according to various examples. FIG. 3 includes particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

FIG. 3 shows a printer 30 including a data input port 31, a processing unit 32, a print engine 33 and a preview image target 34. The data input port 31 is connects to a communications link 40. The printer receives a raster image 50 and preview image 55 from a client computer device 20 as an input at the data input port 31. In one example, the raster image 50 and preview image 55 are prepared as described in FIGS. 1 and 2. The processing unit 32 directs the raster image received at the data input port 31 to the print engine and the preview image to the preview image target 33. In one example, the data input port 31 is, or feeds received data to, a buffer.

The print engine 33 produces a physical image on a print medium, e.g. paper, from the received raster image. The preview image target displays the received preview image to the user or operator of the printer.

In one example, as shown in FIG. 4a, the preview image target 34 includes a display 100 and a user input device 110. Upon receipt of the preview image 55, the display 100 outputs a visual representation which can then be viewed by a user or operator. In one example, the user input device 110 includes a control 120 that is actuable for a user to request cancellation of a displayed job. Upon detecting actuation of the control, the user input device communicates the cancellation request to the processing unit 32 and/or the print engine 33. In one example, the display 100 is controllable by the user input device 110 to zoom in or out or to scroll the displayed visual representation to vary the view and/or show more or less detail.

FIGS. 4a and 4b are block diagrams illustrating a printer, according to various examples. FIGS. 4a and 4b include particular components, modules, etc. according to various examples. However, in different examples, more, fewer, and/or other components, modules, arrangements of components/modules, etc. may be used according to the teachings described herein. In addition, various components, modules, etc. described herein may be implemented as one or more electronic circuits, software modules, hardware modules, special purpose hardware (e.g., application specific hardware, application specific integrated circuits (ASICs), embedded controllers, hardwired circuitry, Field Programmable Gate Arrays (FPGA), etc.), or some combination of these.

In one example, as shown in FIG. 4b, the preview image target 34 includes a web server 200 that generates a web page 210 containing the received preview image 55. A user can access the web page 210 from a terminal directed to a network address associated with the web server application. In one example, the printer includes a display to display the web page 210.

In one example, the processing unit 32 includes a monitoring module 32a to monitor the input received at the data input port 31 and direct the preview image representing the print job to the preview image target upon receipt. In one example, the monitoring module 32a directs the preview image to the preview image target independently of a completion state of receipt of the raster image or other component of the input at the data input port. In such an example, the preview image is received and displayed before the raster image has been received at the printer, providing additional opportunity to the operator/user to review the print job. In selected examples, the printer is a raster printer. In selected examples, the printer has limited or no print processing capabilities beyond printing a received raster image.

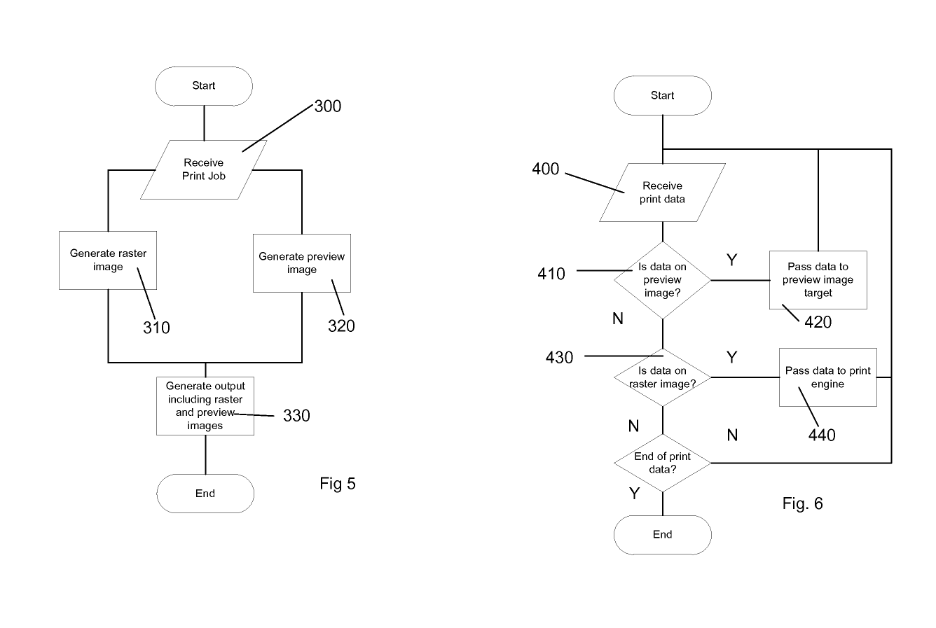

FIG. 5 is a flow diagram of operation in a method according to various examples. In discussing FIG. 5, reference may be made to the diagrams of FIGS. 1 and 2, 3, 4a and 4b to provide contextual examples. Implementation, however, is not limited to those examples. Starting with FIG. 5, in block 300, a print job is received. In one example, the print job originates locally to a computing system executing the method, for example from an application being executed within an operating system which executes the method as a part of its printing routines. In another example, the print job originates remotely from a computing system executing the method. For example, the computing system may be a server hosting a managed print service using one or more print devices, the server receiving print jobs from remote clients and coordinating their ripping before communicating the ripped print job to the designated printer.

Continuing with FIG. 5 at block 310 a raster image of the print job is generated and at step 320 a preview image representing the print job is generated. In one example, the preview image, when displayed, visually corresponds to a print made of the raster image.

Continuing with FIG. 5 at block 330, an output to a remote printer is generated, the output including the raster image of the print job and the preview image representing the print job. In one example, the preview image and raster image are placed in a common carrier for communication to the remote printer. In one example, the preview image is attached to or encapsulated along with the raster image to create the output.

FIG. 6 is a flow diagram of operation in a method according to various examples. In discussing FIG. 6, reference may be made to the diagrams of FIGS. 1 and 2, 3, 4a, 4b and 5 to provide contextual examples. Implementation, however, is not limited to those examples. Starting with FIG. 6, in block 400, print data is received at a printer 30. The print data includes data encoding a preview image and data encoding a raster image.

Continuing with FIG. 6 at block 410, a check is made to determine if the received data is data encoding the preview image and if so, at block 420 the received data is communicated to a preview image target in the printer for display. If the received data is not data encoding the preview image then at block 430 the received data is checked to determine is it is data encoding the raster image. If the received data is data encoding the raster image then the received data is communicated to a print engine for printing in block 440. In one example, in parallel to blocks 400-440, a loop may be performed monitoring for a cancellation command and, should a cancellation command be received, the method of blocks 400-440 is interrupted, cancelled or otherwise temporarily suspended or permanently terminated.

The functions and operations described with respect to diagnostic module may be implemented as a computer-readable storage medium containing instructions executed by a processor and stored in a memory. Processor may represent generally any instruction execution system, such as a computer/processor based system or an ASIC (Application Specific Integrated Circuit), a Field Programmable Gate Array (FPGA), a computer, or other system that can fetch or obtain instructions or logic stored in memory and execute the instructions or logic contained therein. Memory represents generally any memory configured to store program instructions and other data.

Various modifications may be made to the disclosed examples and implementations without departing from their scope. Therefore, the illustrations and examples herein should be construed in an illustrative, and not a restrictive, sense.

What is claimed is:

1. A method for providing a print job preview comprising:
receiving a print job;
generating a raster image of the print job;
generating a preview image representing the print job; and,
generating an output to a remote printer, the output including the raster image of the print job and the preview image representing the print job.

2. The method of claim 1, further comprising:
ordering the preview image ahead of the raster image of the print job in the output.

3. The method of claim 1, further comprising:
encapsulating the raster image of the print job and the preview image in a data stream to be output to the remote printer.

4. The method of claim 1, further comprising:
including a print job identifier in the output identifying a position of the raster image of the print job; and,
including a preview image identifier identifying position of the preview image in the output.

5. The method of claim 1, further comprising:
determining a preview image resolution in dependence on the print job;
wherein the step of generating the preview image includes generating the preview image having the preview image resolution.

6. The method of claim 1, wherein the step of generating the raster image of the print job includes generating halftone data corresponding to the print job.

7. A non-transitory computer-readable storage medium containing instructions to provide a print job preview, the instructions when executed by a processor causing the processor to:
receive a print job;
generate a raster image from the print job and a preview image corresponding to the raster image;
generate an output to a remote printer, the output including the raster image with the preview image.

8. The non-transitory computer-readable storage medium of claim 7, further comprising instructions when executed by the processor causing the processor to:
order the preview image ahead of the raster image of the print job in the output.

9. The non-transitory computer-readable storage medium of claim 7, further comprising instructions when executed by a processor causing the processor to:
encapsulate the raster image and the preview image in a data stream to be output to the remote printer.

10. The non-transitory computer-readable storage medium of claim 7, further comprising instructions when executed by the processor causing the processor to:
include a print job identifier in the output identifying a position of the raster image of the print job; and,
include a preview image identifier identifying position of the preview image in the output.

11. The non-transitory computer-readable storage medium of claim 7, wherein the print job identifier and preview image identifier comprise printer command escape sequences.

12. The non-transitory computer-readable storage medium of claim 7, further comprising instructions when executed by the processor causing the processor to:
to apply a JPEG encoding algorithm to the print job to generate the preview image.

13. The non-transitory computer-readable storage medium of claim 7, further comprising instructions when executed by the processor causing the processor to:
determine a preview image resolution in dependence on the print job; and,
generate the preview image having the preview image resolution.

14. The non-transitory computer-readable storage medium of claim 7, further comprising instructions when executed by a processor causing the processor to:
generate the raster image of the print job including applying a halftoning algorithm to the print job.

15. A printer comprising:
a data input port to receive an input including a raster image of a print job and a preview image representing the print job;
a preview image target to display the preview image representing the print job;
a print engine to print the raster image of the print job;
a processing unit to direct the raster image of the print job to the print engine and the preview image representing the print job to the preview image target.

16. The printer of claim 15, wherein the preview image target comprises a display.

17. The printer of claim 15, wherein the preview image target comprises a web page.

18. The printer of claim 17, further comprising a web server in the printer to receive the preview image and generate the web page including the preview image.

19. The printer of claim 15, wherein the processing unit includes a monitoring module to monitor the input received at the data input port and direct the preview image representing the print job to the preview image target upon receipt.

20. The printer of claim 19, wherein the monitoring module directs the preview image to the preview image target independently of a completion state of receipt of the input at the data input port.
